(19) United States
(12) Patent Application Publication
(10) Pub. No.: US 2024/0080835 A1
(43) Pub. Date: Mar. 7, 2024

(54) COMMUNICATION SYSTEM, COMMUNICATION CONTROL PROGRAM, AND COMMUNICATION CONTROL METHOD

(71) Applicant: Konica Minolta, Inc., Tokyo (JP)

(72) Inventors: Takehisa YAMAGUCHI, Tokyo (JP); Yuji OKAMOTO, Tokyo (JP)

(21) Appl. No.: 18/272,447

(22) PCT Filed: Oct. 26, 2021
(86) PCT No.: PCT/JP2021/039413

§ 371 Date: Jul. 14, 2023

(30) Foreign Application Priority Data
Jan. 25, 2021 (JP) 2021-009446

(51) Int. Cl. H04W 72/1263

(52) U.S. Cl. CPC H04W 72/1263

(57) ABSTRACT

A communication system includes a terminal device including a sensing device, a network system including wireless communication, and a server that transmits to and receives from the terminal device through the network system via wireless communication. The communication system includes a controller that dynamically controls a transport ratio of an uplink channel to a downlink channel, considering a direction from the terminal device to the server is an uplink channel and a direction from the server to the terminal device is a downlink channel, and the controller adjusts the transport ratio according to a condition of data transport or a type of data transport.

### TECHNICAL FIELD

The present invention relates to a communication system, a communication control program, and a communication control method.

### BACKGROUND ART

In the fifth generation mobile communication system (5G), in addition to its use through communication carriers, a self-operated private 5G (also referred to as local 5G) is also attracting attentions. In particular, in a private 5G environment, it is possible to enjoy original specifications of 5G at a high level, such as freely switching between uplink channel and downlink channel, the number of simultaneous connections of terminal devices, and low latency characteristics.

Meanwhile, in 5G, the amount of data from connected various terminal devices increases. When processing is concentrated on a cloud or in a device called an edge server, the channel is congested even using 5G. In order to avoid such channel congestion, it is considered that the terminal device takes charge of advanced processing. However, in order to cause the terminal device to perform advanced processing, the scale of the terminal device increases in terms of both hardware and software, so that its operation becomes difficult in terms of power, cost, and the like.

In recent years, the number of electronic devices (hereinafter, also simply referred to as devices) on which a system-on-a-chip (SoC) with a built-in field-programmable gate array (FPGA) capable of reconstructing the function or a graphics processing unit (GPU)/demand-side platform (DSP) capable of changing the function for various purposes by changing the program is mounted has been increasing. By constructing the function for each purpose to execute, as hardware, various types of processing, these devices can satisfy the performance that is substantially similar to that of dedicated hardware. In addition, these devices consume less power than the dedicated hardware. Furthermore, since the function can be changed in accordance with the purpose, the cost can be suppressed as compared with the case of using pre-designed dedicated hardware.

As for the change or the reconstruction of the function of these devices, for example, in a case of a simple device for collecting information, a service technician manually handles the change or the reconstruction of the device during a time period when the operation frequency thereof is low. In a case where automation is in progress, an update time is specified and data for the update is downloaded to the inside storage of the device. In this case, the update is often performed by restarting the device during a time period when there is relatively less disruption even if the update fails.

In addition, one communication channel is shared for the uplink and the downlink. Thus, when downloading data for an update, it is required to transmit the data at a timing when there is a relatively comfortable margin in the downlink communication condition, or to divide the data into low-capacity units to transmit the data over a period of time.

For example, according to the conventional technique in Patent Literature 1, data is uploaded from a terminal device including an in-vehicle sensor, through a communication channel, to a server. At the time of the upload, in Patent Literature 1, either information from the in-vehicle sensor or information on an analysis result by the terminal device is transmitted in accordance with a change in the channel speed of the communication channel. Thus, according to Patent Literature 1, even in a case where the channel speed decreases in uploading of data, the real-time property of information is not impaired.

In addition, for example, in Patent Literature 2, an operating environment after a software update is constructed in a second information processing system, and an operating environment before the software update in a first information processing system is moved to the second information processing system. Then, in Patent Literature 2, the second information processing system is caused to execute the software after the update, and the information to be processed by the second information processing system is changed from the information obtained by executing the software before the update to the information obtained by executing the software after the update. The invention according to Patent Literature 2 is applied to an information processing device with limited information processing resources such as a server in an Internet of things (IoT) system. In Patent Literature 2, it is described that a software update processing that is executed by such an information processing device with limited information processing resources can be certainly executed without stopping the information processing device.

### CITATION LIST

### Patent Literature

Patent Literature 1: JP 2019-176311 A
Patent Literature 2: WO 2017/179537 A1

### SUMMARY OF INVENTION

### Technical Problems

However, in the technique according to Patent Literature 1, no countermeasure is taken for a delay in transmitting data from the server to the edge device. In addition, in the technique according to Patent Literature 2, no countermeasure is taken for a delay in the communication channel.

Thus, with the conventional technique, it is difficult, for example, to reflect data learned by the server in the edge device (terminal device) in real time.

In addition, in some cases, a terminal device may include versatile hardware such as an FPGA or a GPU/DSP and the function may be changed by reconstructing the hardware. In these cases, it is necessary to quickly and accurately transmit, to the terminal device, the data for reconstruction to cause the terminal device to restart itself. However, with the conventional technique, if there is a delay in the communication channel during downloading, it is required to reduce the frequency of the reconstruction resulting from an update. Thus, updating or reconstructing in each of connected terminal devices is difficult.

Therefore, an object of the present invention is to provide a communication system, a communication control program, and a communication control method that enable real-time reconstruction in a terminal device with reflecting data from a server in the terminal device in real time.

### Solution to Problems

The above-described object of the present invention is achieved by the following means.

(1) A communication system including a terminal device including a sensing device,
a network system at least a part of which includes wireless communication; and
a server that performs data transport with the terminal device through the network system via wireless communication, in which
the communication system includes a controller that dynamically controls a transport ratio of an uplink channel to a downlink channel, considering a direction from the terminal device to the server is an uplink channel and a direction from the server to the terminal device is a downlink channel, and
the controller adjusts the transport ratio according to a condition of data transport or a type of data transport.

(2) The communication system according to (1) described above, in which the controller adjusts the transport ratio to make a transport amount of the uplink channel larger when an amount of data from the terminal device to the server is larger than an amount of data from the server to the terminal device.

(3) The communication system according to (1) or (2) described above, in which the controller adjusts the transport ratio to make a transport amount of the downlink channel larger when an amount of data from the server to the terminal device is larger than an amount of data from the terminal device to the server.

(4) The communication system according to any one of (1) to (3) described above, in which the controller adjusts the transport ratio in response to a request from the terminal device.

(5) The communication system according to (4) described above, in which the terminal device requests the controller to make a transport amount of a downlink channel larger on reception of a notification of completion of data transmission preparation from the server.

(6) The communication system according to (5) described above, in which the server notifies the terminal device of data size of data to be transmitted to the terminal device.

(7) The communication system according to (6) described above, in which the terminal device requests to adjust the transport ratio according to the data size.

(8) The communication system according to any one of (5) to (7) described above, in which the server notifies the terminal device of viability of suspension of data transmission, the terminal device includes a storage that stores data, and the terminal device stores data from the sensing device in the storage in a case where data transmission cannot be suspended.

(9) The communication system according to any one of (1) to (8) described above, in which the terminal device requests the controller to make a transport amount of an uplink channel larger after completion of reception of data transmitted from the server.

(10) The communication system according to (9) described above, in which the controller adjusts the transport ratio to make a transport amount of the uplink channel larger when there is no request for transport ratio change from the terminal device within a predetermined time period after adjustment for making a transport amount of the downlink channel larger.

(11) The communication system according to (9) described above, in which the server requests the controller to make a transport amount of the uplink channel larger when there is no request for data transmission from the terminal device within a predetermined time period after the transport ratio is adjusted to make a transport amount of the downlink channel larger by the controller.

(12) The communication system according to any one of (1) to (11) described above, in which the server generates a control program and/or logical data for operating the terminal device and transmits the control program or the logical data to the terminal device.

(13) The communication system according to (12) described above, in which the controller adjusts the transport ratio to make a transport amount of the downlink channel larger during transmission of the control program and/or the logical data.

(14) The communication system according to (13) described above, in which the control program or the logical data includes a machine learning algorithm used in the terminal device.

(15) The communication system according to any one of (12) to (14) described above, in which the server notifies the terminal device that transmission preparation of the control program and/or the logical data is completed.

(16) The communication system according to any one of (1) to (15) described above, in which the terminal device and/or the server learns using data obtained by the sensing device and changes a function of the terminal device.

(17) The communication system according to any one of (1) to (16) described above, wherein the terminal device includes a plurality of the sensing devices.

(18) A communication control program for controlling a communication system comprising: a terminal device including a sensing device;
a network system at least a part of which includes wireless communication; and
a server that performs data transport with the terminal device through the network system via wireless communication, in which
the communication system includes a computer that dynamically controls a transport ratio of an uplink channel to a downlink channel, considering a direction from the terminal device to the server is an uplink channel and a direction from the server to the terminal device is a downlink channel, and
in which the communication control program causes the computer to execute: a step (a) of adjusting the transport ratio according to a condition of data transport or a type of data transport.

(19) The communication control program according to item (18) described above, in which the step (a) includes adjusting the transport ratio to make a transport amount of the uplink channel larger when an amount of data from the terminal device to the server is larger than an amount of data from the server to the terminal device.

(20) The communication control program according to (18) or (19) described above, in which the step (a) includes adjusting the transport ratio to make a transport amount of the downlink channel larger when an amount of data from the server to the terminal device is larger than an amount of data from the terminal device to the server.

(21) The communication control program according to any one of (18) to (20) described above, in which the step (a) includes adjusting the transport ratio in response to a request from the terminal device.

(22) The communication control program according to Item (21) described above, including a step (b) of adjusting the transport ratio to make a transport amount of the uplink channel larger when there is no request for transport ratio change from the terminal device within a predetermined time period after adjustment for making a transport amount of the downlink channel larger in the step (a).

(23) A communication control method for controlling a communication system comprising a terminal device including a sensing device,
a network system at least a part of which includes wireless communication, and
a server that performs data transport with the terminal device through the network system via wireless communication, and
the communication control method including dynamically controlling a transport ratio of an uplink channel to a downlink channel according to a condition of data transport or a type of data transport, considering a direction from the terminal device to the server is an uplink channel and a direction from the server to the terminal device is a downlink channel.

### Advantageous Effects of Invention

In the present invention, the transport ratio of the uplink channel to the downlink channel is adjusted according to the condition of data transport or the type of data transport. Accordingly, in the present invention, since the channel priority can be adjusted according to the necessity for the uplink or the downlink in data transport, a delay in data transport decreases. This enables real-time reconstruction in the terminal device with reflecting data from the server in the terminal device in real time.

### BRIEF DESCRIPTION OF DRAWINGS

FIG. 1 is a diagram illustrating a schematic configuration of a communication system according to an embodiment of the present invention.

FIG. 2 is a block diagram for illustrating a function of the communication system according to an embodiment.

FIG. 3 is a block diagram illustrating an example of hardware configuration of a terminal device.

FIG. 4 is a block diagram illustrating an outline of hardware configuring a network system.

FIG. 5 is a block diagram illustrating an outline of hardware configuring a server.

FIG. 6 is a flowchart illustrating processing procedure according to a first embodiment.

FIG. 7 is a flowchart illustrating processing procedure according to a second embodiment.

FIG. 8 is a flowchart illustrating processing procedure according to a third embodiment.

FIG. 9 is a flowchart illustrating processing procedure according to a fourth embodiment.

### DESCRIPTION OF EMBODIMENTS

Hereinafter, embodiments of the present invention will be described in detail with reference to the drawings. Note that in the description of the drawings, the same elements are denoted by the same reference signs, and redundant description thereof will be omitted. In addition, dimensional ratios in the drawings are exaggerated for convenience of description and may be different from actual ratios.

### First Embodiment

### (Communication System)

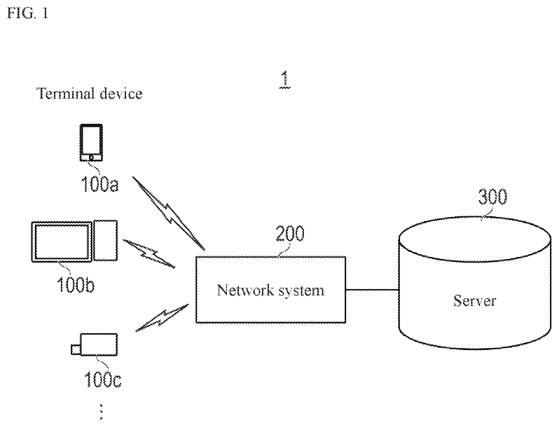

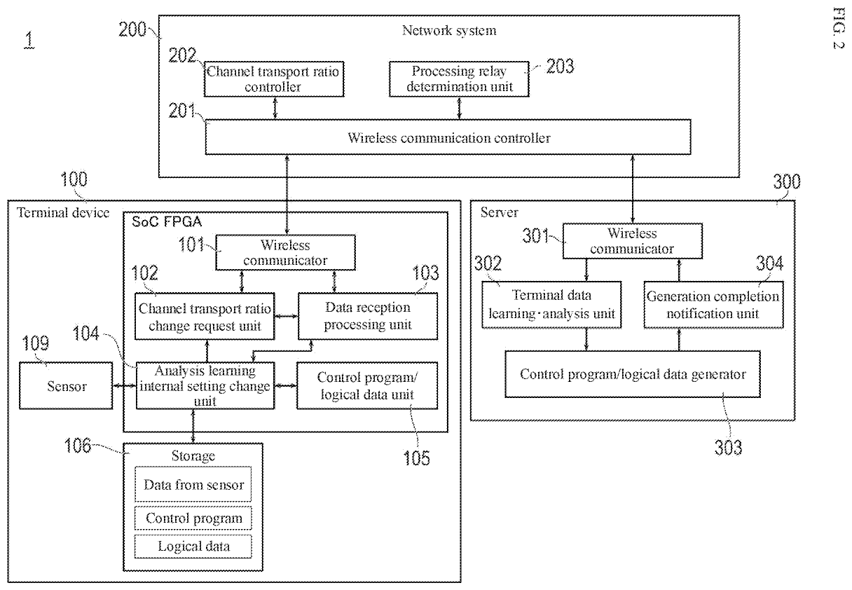

FIG. 1 is a diagram illustrating a schematic configuration of a communication system 1 according to an embodiment of the present invention. FIG. 2 is a block diagram for illustrating a function of the communication system 1 according to an embodiment.

As illustrated in FIGS. 1 and 2, the communication system 1 according to an embodiment includes the following.
terminal devices 100 (100a, 100b, 100c, . . . )
a network system 200
and a server 300

The communication system 1 is, for example, a private 5G communication system.

### (Terminal Device 100)

First, the terminal device 100 will be described. The terminal device 100 includes a sensing device (hereinafter simply referred to as a sensor 109), and transmits information detected by the sensor 109 to the server 300. In addition, the terminal device 100 also performs machine learning and determination on its own from information detected by the sensor 109.

Such a terminal device 100 is also referred to as an edge device, an edge terminal, or the like, and is an electronic device that can also be used for IoT. The terminal device 100 is, for example, as follows.
a portable terminal device 100a such as a smartphone or a tablet computer
a fixed terminal device 100b such as a personal computer
a monitoring camera device 100c with a wireless device attached to a camera and the like

These terminal devices 100a, 100b, and 100c are all devices in which the sensor 109 and a computer including a wireless communication function are integrated or locally connected. In the description, these terminal devices 100a, 100b, and 100c are referred to as terminal device 100 unless otherwise specified.

As illustrated in FIG. 2, the terminal device 100 includes the following.
a wireless communicator 101
a channel transport ratio change request unit 102
a data reception processing unit 103
an analysis learning internal setting change unit 104
a control program/logical data unit 105

In the terminal device 100, a storage 106 and the sensor 109 are connected (or integrated).

The wireless communicator 101 communicates with the network system 200 in 5G.

The channel transport ratio change request unit 102 requests the network system 200 to change the channel transport ratio. A channel used for communication in a direction from the terminal device 100 to the server 300 is an uplink channel, and a channel used for communication in a direction from the server 300 to the terminal device 100 is a downlink channel. The transport ratio is a ratio of the transport amount of the uplink channel to the transport amount of the downlink channel. The channel transport ratio change request unit 102 requests the network system 200 to change the transport ratio.

A data reception processing unit 103 processes data transmitted to and received from the server 300. The data transmitted from the terminal device 100 is, for example, data collected by the sensor 109, data generated by the analysis learning internal setting change unit 104, or the like. The data reception processing unit 103 once receives these pieces of data from the respective units to perform necessary processing thereon, and outputs them to the wireless communicator 101. The necessary processing is, for example, labeling, integration or compression of data, other data processing, or the like.

The wireless communicator 101 transmits these pieces of data to the network system 200. The network system 200 transmits these pieces of data, in accordance with the destination of the data, to the server 300. On the other hand, the data received from the server 300 is, for example, a control program and/or logical data for controlling the terminal device 100. These pieces of data transmitted from the server 300 are received, via the network system 200, by the wireless communicator 101 of the terminal device 100. The received data is once output by the wireless communicator 101 to the data reception processing unit 103. The data reception processing unit 103 performs necessary processing on the received data to output them to each unit. The necessary processing is, for example, decompression or expansion of integrated or compressed data, sorting according to labeling, other re-processing or restoration of processed data, or the like.

The analysis learning internal setting change unit 104 analyzes and/or learns the data input from the sensor 109. For example, in a case where the sensor 109 is an image sensor, the analysis learning internal setting change unit 104 analyzes the image data in time series through image processing to determine a change in the image and to identify a person or an object. The learning by the analysis learning internal setting change unit 104 is, for example, machine learning using image data. An example of the machine learning includes deep learning. Specifically, for example, in the analysis by the analysis learning internal setting change unit 104, the following processing is performed based on a previous learning result or the control program and/or the logical data transmitted from the server 300. The analysis learning internal setting change unit 104 executes, from the image data detected by the sensor 109, immediate identification of a person or an object, counting of the number of people or objects, and the like. In addition, in a case where the sensor 109 is a thermal camera, in the analysis by the analysis learning internal setting change unit 104, determination of the temperature of a person or an object, identification of a person or an object with no less than a certain temperature, or the like is performed. In addition, in the learning by the analysis learning internal setting change unit 104, for example, the machine learning is performed using data of persons as teaching data and using image data from the sensor 109 as an input. Accordingly, the learning result used for identification of a person can be obtained. Note that the analysis learning internal setting change unit 104 may execute either the analysis or the learning or may execute both of them according to the performance of the terminal device 100.

In addition, the analysis learning internal setting change unit 104 changes, from the result of the analysis and/or the learning, the internal setting of the terminal device 100 to be optimized.

The control program/logical data unit 105 stores a control program and/or logical data for operating the terminal device 100 based on the result analyzed and/or learned by the analysis learning internal setting change unit 104. In addition, the control program/logical data unit 105 stores a control program and/or logical data for operating the terminal device 100 downloaded from the server 300. Although details will be described below, as a hardware configuration, in a case of an FPGA, the control program/logical data unit 105 is configured as a memory area in the same chip as for a CPU function. In addition, as a hardware configuration, in a case where a CPU and a memory are separated, the control program/logical data unit 105 is configured by a semiconductor memory such as a RAM connected to the CPU. In any case, the control program/logical data unit 105 stores the control program and/or the logical data in an immediately executable state.

The storage 106 stores the result analyzed and/or learned by the analysis learning internal setting change unit 104. In addition, the storage 106 stores the data from the sensor 109. In addition, the storage 106 stores the control program and/or the logical data for operating the terminal device 100. The control program and/or the logical data stored in the storage 106 are not immediately executed, but are stored so as to be read into the control program/logical data unit 105 upon an instruction to change the function.

Note that there is no need to store all of the above-described information in the storage 106, and the capacity of the storage 106 is determined in accordance with the cost of the terminal device 100. Then, the content stored in the storage 106 may be appropriately changed in accordance with the capacity. For example, the storage 106 may store only data from the sensor 109. In this case, the terminal device 100 downloads the control program and/or the logical data from the server 300 for use.

Alternatively, the storage 106 may not necessarily be included. In this case, the terminal device 100 downloads the control program and/or the logical data from the server 300 for use. Since the storage 106 is not included, a further cost reduction of the terminal device 100 is achieved.

The sensor 109 is, for example, an image sensor. The image sensor is, for example, a camera that mainly detects visible light. In addition, the sensor 109 is an infrared camera, a thermal camera (temperature detection camera), or the like. In addition, as the sensor 109, for example, the following various sensors can be used.
an acoustic sensor that detects sound like a microphone
an altitude sensor that detects altitude (above sea level)
an atmospheric pressure sensor
an underwater depth sensor (water pressure sensor)
a vibration sensor
an orientation sensor
an angle sensor
a temperature sensor
a voltage sensor
an electric current sensor
an electric power sensor and the like

Data detected by these sensors 109 is transmitted to the server 300 as necessary. In addition, the data detected by the sensors 109 is also stored in the storage 106 as necessary.

Note that the terminal device 100 may be provided with, for example, the following wireless communication interfaces and the like in addition to the communication in 5G.
Ethernet (R),
a network interface based on a standard such as IEEE1394,
Bluetooth (R),
a wireless communication interface such as IEEE802.11 and the like may also be included therein.

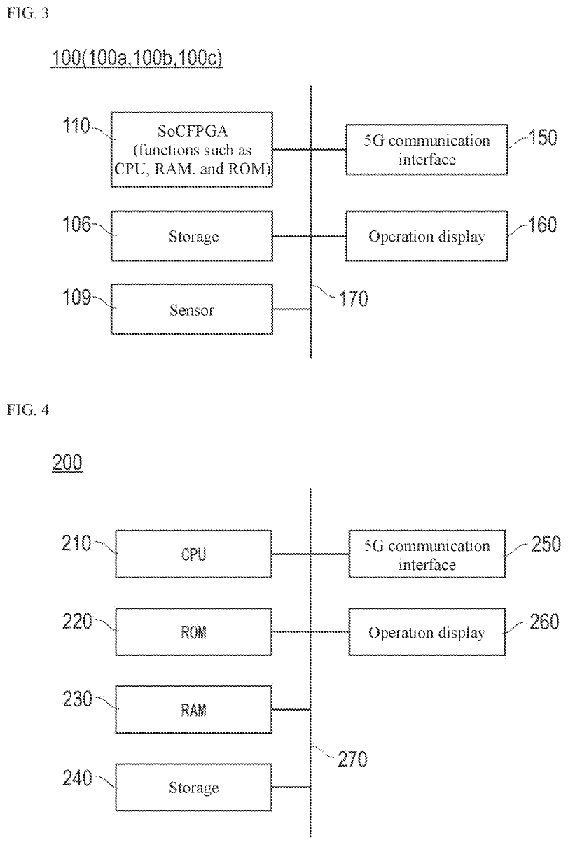

FIG. 3 is a block diagram illustrating an example of a hardware configuration of the terminal device 100.

The terminal device 100 is a computer. As illustrated in FIG. 3, the terminal device 100 includes a SoCFPGA 110, the storage 106, a 5G communication interface 150, and an operation display 160.

The SoCFPGA 110 is a semiconductor device (including a semiconductor device in which a plurality of chips is bonded) in which an FPGA that can rewrite processing content to be executed is formed as a system in one chip. The SoCFPGA 110 may also be referred to as a programmable SoC. In the SoCFPGA 110, the following functions are formed in one chip (or a plurality of chips including these plural functions is integrated).
a central processing unit (CPU) serving as an arithmetic element,
a read only memory (ROM) serving as a storage element,
a random access memory (RAM) and the like

In addition, an accelerator such as a GPU/DSP may be mounted on the SoCFPGA 110. Such a SoCFPGA 110 stores a control program and/or logical data necessary for the operation (including rewriting of a gate circuit in the FPGA). Then, those are executed, and thus the functions of the respective units of the terminal device 100 described above are implemented. Thus, the SoCFPGA 110 functions as the channel transport ratio change request unit 102, the data reception processing unit 103, the analysis learning internal setting change unit 104, and the control program/logical data unit 105.

The storage 106 is a storage medium as follows.
an embedded MultiMediaCard (eMMC) or a solid state drive (SSD),
a hard disk drive (HDD) or the like.

Alternatively, the storage 106 may be a portable storage medium such as a memory card.

The 5G communication interface 150 is the wireless communicator 101 for communicating with the network system 200 in 5G, and includes a communication module chip. Note that the 5G communication interface 150 may also be integrated as the SoCFPGA 110.

The operation display 160 is, for example, a touch panel type display, and the operation display 160 displays various types of information and receives various types of input from a user. In addition, depending on the terminal device 100, an input device such as a keyboard or a mouse and a monitor or the like may be connected to each other.

Note that the terminal device 100 is not limited to the SoCFPGA 110, and may be an FPGA other than a SoC. In addition, the terminal device 100 may have a form in which a CPU, a RAM, a ROM, and the like are independent and are connected through a bus.

### (Network System 200)

Next, the network system 200 will be described. The network system 200 includes a wireless 5G communication function and controls communication between the terminal device 100 and the server 300.

As illustrated in FIG. 2, the network system 200 includes a wireless communication controller 201, a channel transport ratio controller 202, and a processing relay determination unit 203. The network system 200 communicates with the terminal device 100 and the server 300 in 5G. Thus, the network system 200 is a radio base station and a core network device of 5G.

The wireless communication controller 201 controls communication with other electronic devices. In the present embodiment, the wireless communication controller 201 controls 5G communication between the terminal device 100 and the server 300.

The channel transport ratio controller 202 (controller) dynamically adjusts the transport ratio between the uplink channel to the downlink channel. The transport ratio is adjusted according to, for example, the condition and the type of data transmitted and received between the terminal device 100 and the server 300.

For example, the channel transport ratio controller 202 determines the condition of transmitted and received data based on a difference in the amount of data transmitted and received between the terminal device 100 and the server 300 to adjust the transport ratio according to the determined condition of data. Specifically, for example, the channel transport ratio controller 202 monitors the communication amount of the wireless communication controller 201, and acquires each of the uplink transport amount and the downlink transport amount to compare them. Accordingly, the channel transport ratio controller 202 determines the condition of data transmitted and received between the terminal device 100 and the server 300. For example, in a situation where the amount of downlink data is larger, the channel transport ratio controller 202 adjusts the transport amount of the downlink channel to be larger. Conversely, in a situation where the amount of uplink data is larger, the channel transport ratio controller 202 adjusts the transport amount of the uplink channel to be larger.

In addition, the channel transport ratio controller 202 adjusts the transport ratio according to, for example, the type of data transmitted and received between the terminal device 100 and the server 300. The type of transmitted and received data is, for example, data as follows.
data related to function change of the terminal device 100 by the server 300,
data detected by the sensor 109 of the terminal device 100,
data of a result of analysis and/or learning by the terminal device 100 and the like.

The data related to function change of the terminal device 100 is data to be downloaded from the server 300 to the terminal device 100, and is transmitted using the downlink channel. On the other hand, the data detected by the sensor 109 of the terminal device 100 and the data of the result of analysis and/or learning by the terminal device 100 are data to be uploaded from the terminal device 100 to the server 300. These pieces of data are transmitted using the uplink channel.

In the first embodiment, the type of data is determined by the terminal device 100. The terminal device 100 transmits a request for transport ratio change to the channel transport ratio controller 202 according to the determined type of data. Accordingly, the channel transport ratio controller 202 adjusts the transport ratio in response to the request received from the terminal device 100. For example, when receiving, from the terminal device 100, a request for prioritizing the uplink, the channel transport ratio controller 202 adjusts the transport amount of the uplink channel to be larger. Conversely, when receiving, from the terminal device 100, a request for prioritizing the downlink, the channel transport ratio controller 202 adjusts the transport amount of the downlink channel to be larger.

In addition, the channel transport ratio controller 202 may adjust the transport ratio in response to a request not only from the terminal device 100 but also from the server 300.

In addition, in a case where there is no request for transport ratio change from either the terminal device 100 or the server 300, the channel transport ratio controller 202 prioritizes a channel predetermined in advance. The channel to be prioritized at the time of no request is, for example, the uplink channel. Some of the terminal devices 100 include, as a main function, a function of transmitting data detected by the sensor 109 to the server 300. Such terminal devices 100 use the uplink channel most of the time during operation. Thus, by prioritizing the uplink at the time of no request for transport ratio change, it is possible to efficiently deliver the data from the sensor 109 to the server 300.

The transport ratio of the uplink channel to the downlink channel may be adjusted, for example, by methods such as those described in the following references:

Reference 1 “Local 5G Column, 5th vol, Latest legal consideration status and key issues and solutions at the time of considering the introduction that have become apparent now”, CTC system management (URL=https://ctcs.secure-link.jp/special/local5g/p0087.htm).

Reference 1 (in particular, see “4. Consideration of TDD synchronization becomes more complicated”), discloses a technique in which a communication time in a communication channel is divided into “time slots” for every extremely short fixed period of time, and with the slot, the uplink (U) and the downlink (D) are distributed.

Reference 2: “Consideration status by the technical study working group, the new-generation mobile communications system committee”, see pages 27 (28th sheet) of a distribution material of the technical study working group, the new-generation mobile communications system committee, the information and communication technology subcommittee, Information and Communications Council, the Ministry of Internal Affairs and Communications on Feb. 27, 2018 (the 6th session). (URL=https://www.soumu.go.jp/main content/000536171.pdf).

Reference 2 discloses a technique of flexibly setting of a switching cycle of download (DL)/upload (UL) as a semi-static TDD, and a technique of switching DL/UL for each symbol as dynamic TDD.

The transport ratio of the uplink channel to the downlink channel may be adjusted by other methods.

When detecting communication malfunction, the processing relay determination unit 203 stops the communication and reset the setting to the original setting.

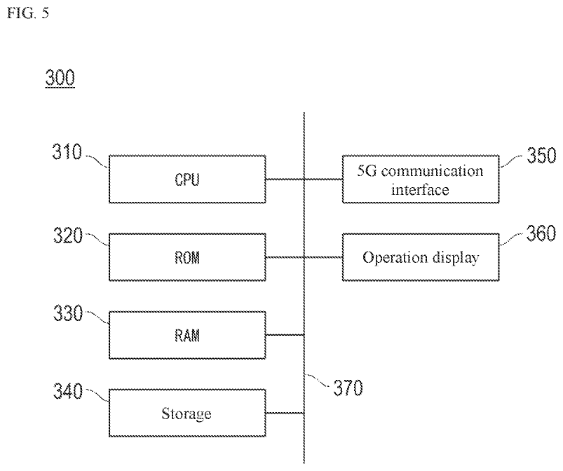

FIG. 4 is a block diagram illustrating an outline of hardware configuring the network system 200.

The network system 200 is a computer. As illustrated in FIG. 4, the network system 200 includes the following.
a CPU 210
a ROM 220
a RAM 230
a storage 240
a 5G communication interface 250
an operation display 260

These components are communicably connected to each other via a bus 270.

The CPU 210 executes functions of the respective units of the network system 200 described above by executing programs recorded in the ROM 220 and the storage 240.

The ROM 220 stores therein various kinds of programs and various kinds of data.

The RAM 230, as a workspace, temporarily stores therein programs and data.

The storage 240 stores therein various types of programs including an operating system, and various types of data. The storage 240 is a storage medium as follows.
an embedded MultiMediaCard (eMMC) or a solid state drive (SSD),
a hard disk drive (HDD) or the like.

The 5G communication interface 250 serves as the wireless communication controller 201 to communicate with the terminal device 100 and the server 300 in 5G.

The operation display 260 is, for example, a touch panel type display, and the operation display 260 displays various types of information and receives various types of input from a user. In addition, as the operation display 260, an input device such as a keyboard or a mouse and a monitor or the like may be connected to each other.

Note that the channel transport ratio controller 202 (controller) may not be provided in the network system 200. For example, the channel transport ratio controller 202 (controller) may be implemented by a computer installed in a remote location. For example, a computer serving as the channel transport ratio controller 202 may be connected to the network system 200 that includes the wireless communication controller 201 and the processing relay determination unit 203 to execute processing for dynamically controlling the transport ratio.

### (Server 300)

Next, the server 300 will be described. The server 300 analyzes and/or learns the data transmitted from the terminal device 100. In addition, the server 300 stores a control program and/or logical data for function change of the terminal device 100. In addition, the server 300 generates a control program and/or logical data for function change of the terminal device 100. In addition, the server 300 changes the setting (function) of the terminal device 100.

As illustrated in FIG. 2, the server 300 includes a wireless communicator 301, a terminal data analysis learning unit 302, a control program/logical data generator 303, and a generation completion notification unit 304. When the terminal device 100 is referred to as an edge terminal, in contrast to that, the server 300 may be referred to as an edge server. In addition, the server 300 stores, on the network, data collected by the terminal device 100 from the sensor 109, the control program and/or the logical data used by the terminal device 100, and the like. Thus, the server 300 may be referred to as a cloud server.

The wireless communicator 301 communicates with the network system 200 in 5G.

The terminal data analysis learning unit 302 analyzes and learns data received from the terminal device 100. The terminal data analysis learning unit 302 analyzes the condition of the terminal device 100 from the data received from the terminal device 100. In addition, the terminal data analysis learning unit 302 performs machine learning using data received from the terminal device 100. The server 300 has higher performance and higher functionality than the terminal device 100. Thus, the terminal device 100 can deal with difficult machine learning. The results of the analysis or the machine learning is output to the control program/logical data generator 303.

The control program/logical data generator 303 generates a control program and/or logical data optimal for the terminal device 100 from the result of the analysis or the machine learning.

The control program and/or the logical data is a program and/or data for operating the terminal device 100. The control program and/or the logical data is, for example, a necessary program and/or data when another learning is further required in a case where the terminal device 100 performs machine learning from data detected by the sensor 109 included in the terminal device 100 itself. The control program/logical data generator 303 may determine on what kind of control program and/or logic data are to be generated based on the result of the machine learning, for example.

Note that the control program for the hardware of the terminal device 100 is a program executed mainly by the CPU of the terminal device 100 or the circuit of the CPU function in the FPGA. Meanwhile, the logical data is mainly data for rewriting circuit data of the FPGA.

The control program and/or the logical data is, for example, in a case where the data from the sensor 109 is determined by the terminal device 100, a program and/or data that serves as the criteria for the determination. For example, when a person or an object is determined by the terminal device 100, the control program/logical data generator 303 generates a program and/or data necessary for determination of a person or an object by the terminal device 100.

The control program/logical data generator 303 outputs the completion of the generation of the control program and/or the logical data to the generation completion notification unit 304.

Note that the control program and/or the logical data may be stored in the storage 340 of the server 300 in advance. In this case, for example, it may be assumed in advance what case the function of the terminal device 100 is to be changed, and a control program and/or logical data corresponding to the assumption may be stored therein.

The generation completion notification unit 304 receives the output of the completion of generation from the control program/logical data generator 303, and then notifies the terminal device 100 that the transmission preparation of the control program and/or the logical data is completed. In addition, in a case where the control program and/or the logical data that is stored is transmitted, the generation completion notification unit 304 outputs, to the wireless communicator 301, a notification that transmission preparation has been completed when these data are ready to be transmitted. The wireless communicator 301 notifies the terminal device 100 of the completion of transmission preparation via the network system 200.

The terminal device 100 requests the network system 200 to prioritize the downlink at the time of receiving, from the server 300, the notification of the completion of the data transmission preparation. Accordingly, the network system 200 is adjusted so that the transport amount of the downlink channel to be larger. Subsequently, the server 300 transmits the control program and/or the logical data from the wireless communicator 301 to the terminal device 100 through the network system 200. Note that the details of the flow of such processing will be described below. Thus, in the first embodiment, the control program and/or the logical data can be transmitted from the server 300 to the terminal device 100 efficiently and in real time.

FIG. 5 is a block diagram illustrating an outline of hardware configuring the server 300.

The server 300 is a computer. As illustrated in FIG. 5, the server 300 includes a CPU 310, a ROM 320, a RAM 330, a storage 340, a 5G communication interface 350, and an operation display 360. These components are communicably connected to each other via a bus 370.

The CPU 310 executes functions of the respective units of the server 300 described above by executing programs recorded in the ROM 320 and the storage 340.

The ROM 320 stores therein various kinds of programs and various kinds of data.

The RAM 330, as a workspace, temporarily stores therein programs and data.

The storage 340 stores therein various types of programs including an operating system, and various types of data. The storage 340 stores the control program and/or the logical data.

In the server 300, a large-capacity storage medium such as an HDD is mainly used as the storage 340. As the storage 340, a semiconductor storage medium such as an eMMC or an SSD may be used together with the HDD or instead of the HDD.

The 5G communication interface 350 serves as the wireless communicator 301 to communicate with the network system 200 in 5G.

The operation display 360 is, for example, a touch panel type display, and the operation display 360 displays various types of information and receives various types of input from a user. In addition, as the operation display 360, an input device such as a keyboard or a mouse and a monitor or the like may be connected to each other.

### (Processing Procedure)

Next, processing procedure of the communication system 1 will be described.

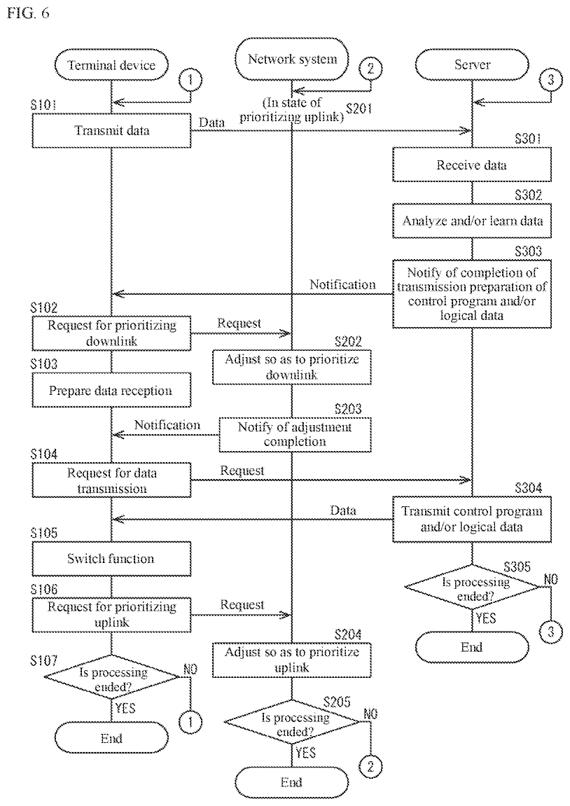

FIG. 6 is a flowchart illustrating processing procedure according to a first embodiment. Here, the processing procedure will be described based on the following assumptions. The terminal device 100 includes an image sensor. The terminal device 100 also performs predetermined machine learning on its own. The server 300 stores, in the storage 340 of the server 300, the control program and/or the logical data for the function change of the terminal device 100. The server 300 analyzes the data from the terminal device to change the function of the terminal device 100 according to the result.

The control program is, for example, a program for controlling a deep learning network. The logical data is, for example, circuit data for an FPGA using a model file of a deep learning network learned in advance.

Here, processing procedure by the terminal device 100, processing procedure of the network system 200, and processing procedure of the server 300 are related to each other, so that they will be described as a series of flows. Note that the processing procedure of the network system 200 is equivalent to the processing executed in accordance with a communication control program.

First, the terminal device 100 transmits (uploads), together with image data detected by the image sensor, data on the analysis result of the image to the server 300 via the network system 200 (S101). At this time, the transport ratio in the network system 200 has already been adjusted so as to prioritize the uplink (S201). Then, the server 300 receives the date from the terminal device 100 (S301).

The analysis and/or the learning in the terminal device 100 is, for example, machine learning using image data acquired by the image sensor as an input, and includes, for example, inference by deep learning. For example, a machine learning algorithm for skeleton detection is executed in the terminal device 100. Accordingly, the terminal device 100 acquires coordinate data of each of joint points of the object recognized as a human. The terminal device 100 recognizes the height or the like of the person set as a target to be captured. The terminal device 100 analyzes the posture, height, and the like of each person from the obtained coordinate data, and transmits the analysis result to the server 300.

After the data transmission, the terminal device 100 continues machine learning from the image acquired by the image sensor for a certain period of time. For example, when the average height of persons who are the targets to be captured is low, the terminal device 100 learns that the targets to be learned of this case are children. In this case, the terminal device 100 recognizes that it is desirable to take data on children and detects a person with no less than a certain height, for example, a person who are 160 cm or higher. In this case, the terminal device 100 sets a threshold value for estimating that the person who is 160 cm or higher is not the target to be analyzed and excluding the person from the target to be analyzed. Alternatively, when there is already a threshold value of the height, the terminal device 100 changes the threshold value.

Next, the server 300 that has received the date from the terminal device 100 further analyzes and/or learns the received date in time series (S302). control program and/or logical data for changing the function of the terminal device 100 The server 300 prepares the transmission of a control program and/or logical data for the function change of the terminal device 100. Upon the completion of the transmission preparation of the control program and/or the logical data, the server 300 notifies the terminal device 100 of the completion of the transmission preparation (S303).

The server 300 analyzes, for example, the posture by the skeleton detection within the received data in time series to learn the posture as the behavior of getting lost. Based on the learning result, the server 300 further analyzes the data from the terminal device 100 to execute determination of human action.

Based on the result of the determination of action, the server 300 determines an algorithm to be executed next by the terminal device 100. In the first embodiment, next, the terminal device 100 is caused to execute a machine learning algorithm for detection of person attribute. Note that in the first embodiment, the server 300 stores the control program and/or the logical data to be executed by the terminal device 100 in accordance with the determination of action that is assumed in advance. Thus, in this embodiment, the control program and/or the logical data for causing the terminal device 100 to execute the machine learning algorithm for the detection of person attribute is stored in the server 300.

The data to be notified to the terminal device 100 is data of data size of the control program and/or the logical data scheduled to be transmitted to the terminal device 100 and the feasibility of suspension of data transmission. The feasibility of suspension of data transmission indicates that whether or not data transmission from the server 300 can be suspended.

The terminal device 100 that has received the notification from the server 300 transmits, to the network system 200, a request for setting the transport ratio prioritizing the downlink (S102). At this time, the terminal device 100 determines, based on the notification from the server 300, the type of data that is transmitted from the server 300. In the terminal device 100, it is determined that which types of data trigger a request for prioritizing the downlink. In the first embodiment, when the type of data is data related to the function change of the terminal device 100, a request for prioritizing the downlink is made. The control program and/or the logical data is data regarding the function change of the terminal device 100. Thus, the terminal device 100 makes the request for prioritizing the downlink.

In addition, at this time, the terminal device 100 may determine whether or not to execute a request for prioritizing the downlink from the data size included in the notification received from the server 300 before executing the request for prioritizing the downlink. For example, the terminal device 100 compares the data size included in the notification from the server 300 with a predetermined threshold value (a threshold value for data size). Then, in a case where the data size included in the notification is less than the threshold value for the data size, the terminal device 100 may not execute the request for prioritizing the downlink. The threshold value of the data size is, for example, data size that provides, during downloading from the server 300, the time interval within which loss of data to be uploaded from the terminal device 100 is tolerated. The time interval within which loss of data is tolerated varies depending on the data communication condition, and thus such a threshold value for the data size may be determined based on past records or the like.

The transport ratio of the uplink channel to the downlink channel may be requested from the terminal device 100. The transport ratio is determined, for example, according to the content of the following processing in the terminal device 100. For example, the terminal device 100 requests the transport ratio such as uplink:downlink=4:6, or the like. In addition, for example, there is a case where the terminal device 100 needs immediate function change, that is, a case where there is a request for switching the processing in the terminal device 100 within 5 seconds, and the like. In this case, the terminal device 100 may request the transport ratio such as uplink:downlink=1:9, or the like. Note that the transport ratio in the case of prioritizing the downlink may be determined in advance in the network system 200. For example, the network system 200 determines the standard transport ratio in the case of prioritizing the downlink as uplink:downlink=4:6. Then, when the transport ratio is not included in the request from the terminal device 100, the network system 200 adjusts to so as to prioritize the downlink using the standard transport ratio.

Next, the terminal device 100 changes its operation to processing for receiving data (data reception preparation) (S103). For the data reception preparation, the processing of the analysis and/or the learning that has been performed by the terminal device 100 and the data transmission (upload) to the server 300 are temporarily suspended. Then, the data reception preparation makes it possible to receive the control program/logical data from the server 300. The program for executing the processing of the data reception preparation is stored in the terminal device 100 in advance, for example. Upon a receipt of the notification of completion of data transmission preparation from the server 300 as a trigger, the terminal device 100 executes a program for data reception preparation.

In addition, when the information notified by the server 300 related to the feasibility of suspension of data transmission indicates that data transmission cannot be suspended, the terminal device 100 activates the storage 106 of itself and accumulates the data from the sensor 109. This is for, in a case where it takes a long time to download data from the server 300 to the terminal device 100, preventing data detected by the sensor 109 from being lost during the download. For example, in a case where it takes 30 seconds to transfer data from the server 300 to the terminal device 100, the data detected by the sensor 109 is lost during the 30 seconds without any countermeasure. Thus, the terminal device 100 activates the storage 106 and causes the storage 106 to store the data detected by the sensor 109 during the 30 seconds. Note that whether or not to store the data in the storage 106 is determined based on the information related to the feasibility of suspension of data transmission and the data size that are notified by the server 300. For example, when the information related to the feasibility of suspension of data transmission indicates that data transmission cannot be suspended, the terminal device 100 estimates, from the notified data size, a time period required for data transfer. When the estimated data transfer time period is not less than a threshold value (a threshold value for the transfer time period), the terminal device 100 causes the storage 106 to store the data detected by the sensor 109. The threshold value for the transfer time period is preferably, for example, a time interval within which loss of data detected by the sensor 109 is tolerated. The data transfer time period varies depending on the data communication condition, and thus such a threshold value for the transfer time period may be determined based on past records or the like.

On the other hand, when the information related to the feasibility of suspension of data transmission indicates that data transmission can be suspended, the terminal device 100 executes the request for suspending the data transmission from the server 300 as necessary. For example, in a case where the available capacity of the storage 106 is small and the data detected by the sensor 109 cannot be stored therein, the terminal device 100 suspends the data transmission. Although not illustrated, the request for suspending the data transmission is executed after a step of S304.

Next, the network system 200 that has received the request for prioritizing the downlink adjusts the transport ratio so as to prioritize the downlink in accordance with the request (S202). After the completion of the adjustment, the network system 200 notifies the terminal device 100 of the completion of the adjustment to prioritize the downlink (S203).

Next, the terminal device 100 that has received, from the network system 200, the notification of the completion of the adjustment of the transport ratio requests the server 300 to transmit data (S104).

Next, the server 300 that has received the request for data transmission transmits (downloads) the control program and/or the logical data to the terminal device 100 (S304).

Next, after the completion of reception of the data, the terminal device 100 changes its function using the control program and/or the logical data that is received (S105). The terminal device 100 restarts itself as necessary in order to operate the control program and/or the logical data that is received.

Accordingly, for example, in the terminal device 100, the machine learning algorithm that has been changed is operated. Here, as described above, the machine learning algorithm that has been changed is the machine learning algorithm for detection of person attribute. Specifically, the machine learning algorithm for detection of person attribute is, for example, learning for lost child determination. The terminal device 100 to which the control program and/or the logical data are downloaded is switched to the machine learning algorithm for detection of person attribute. Thus, the terminal device 100 detects a child from image data acquired by the image sensor and learns its action. Then, as a result of the learning, when the child makes a motion that suggests he/she is lost or cries, the terminal device 100 detects the color of the top and bottom clothing, glasses, the sex, the presence or absence of a hat or a bag, and the like of the child. Furthermore, from these detected results, the terminal device 100 transmits, to the lost child center, information such as the location where the child was detected, the height, the sex, the color of the top and bottom clothing, and the presence or absence of glasses, a hat, or a bag. The lost child center announces the lost child. Accordingly, in this example, it is possible to quickly notify people that there is a lost child in a facility or the like in which the terminal device 100 is provided. This makes it possible to protect the lost children or reunite them with their guardians or the like at an early stage.

After completion of the function switching, the terminal device 100 requests the network system 200 to prioritize the uplink (S106). The transport ratio for prioritizing the uplink may be requested from the terminal device 100 in a similar manner to the case of prioritizing the downlink. For example, the terminal device 100 requests the transport ratio of uplink:downlink=6:4. In addition, for example, when it is assumed that the amount of uplink data increases after the function change of the terminal device 100, the terminal device 100 may request the transport ratio such as uplink:downlink=9:1. Note that the transport ratio in the case of prioritizing the uplink may also be determined in advance in the network system 200. For example, the network system 200 determines the standard transport ratio of uplink in case of prioritizing the uplink as the uplink:downlink=6:4. Then, when the transport ratio is not included in the request from the terminal device 100, the network system 200 adjusts so as to prioritize the uplink sing the standard transport ratio.

Next, the network system 200 that has received the request for prioritizing the uplink adjusts the transport ratio so as to prioritize the uplink (S204). Accordingly, in the communication system 1, data can be transmitted stably at high speed from the terminal device 100 to the server 300.

Subsequently, if there is no instruction to end the processing (S107: NO), the processing returns to a step of S101 and the terminal device 100 continues the subsequent processing. Similarly, if there is no instruction to end the processing (S205: NO), the processing returns to a step of S201 the network system 200 continues the subsequent processing. Similarly, if there is no instruction to end the processing (S305: NO), the processing returns to a step of S301 and the server 300 continues the subsequent processing. Meanwhile, if there is an instruction to end the processing (S107, S205, and S305: YES), each of the terminal device 100, the network system 200, and the server 300 ends the processing (END) when receiving an instruction to end the processing.

The first embodiment described above has the following effects.

In order to provide the terminal device 100 with a plurality of functions, highly functional hardware has been prepared, and the various control programs has been stored in advance in the storage 106 or the like to be switched for use. In the first embodiment, as described above, the channel priority is adjusted according to the necessity of the uplink and downlink in data transport, and thus a delay in the data transport decreases. Thus, in the first embodiment, since the data from the server 300 can be reflected in the terminal device 100 in real time, the terminal device 100 can be reconstructed in real time.

In particular, in the first embodiment, the function of the terminal device 100 is changed by replacing the control program and/or the logical data. At the time of this function change, the downlink is prioritized in response to the request from the terminal device 100. Accordingly, in the first embodiment, by minimizing the hardware resources of the terminal device 100 and frequently reconstructing them, various functions can be satisfied.

### Second Embodiment

The second embodiment differs from the first embodiment described above in terms of a control mode. The first embodiment described above is an example in which the control program and/or the logical data are stored in advance in the storage 340 of the server 300. In the second embodiment, the server 300 generates a new control program and/or logical data by learning data transmitted from the terminal device 100, and transmits the control program and/or the logical data to the terminal device 100 to make the data reflected.

The configuration of the communication system 1 of the second embodiment is similar to that of the first embodiment, so that the description thereof will be omitted.

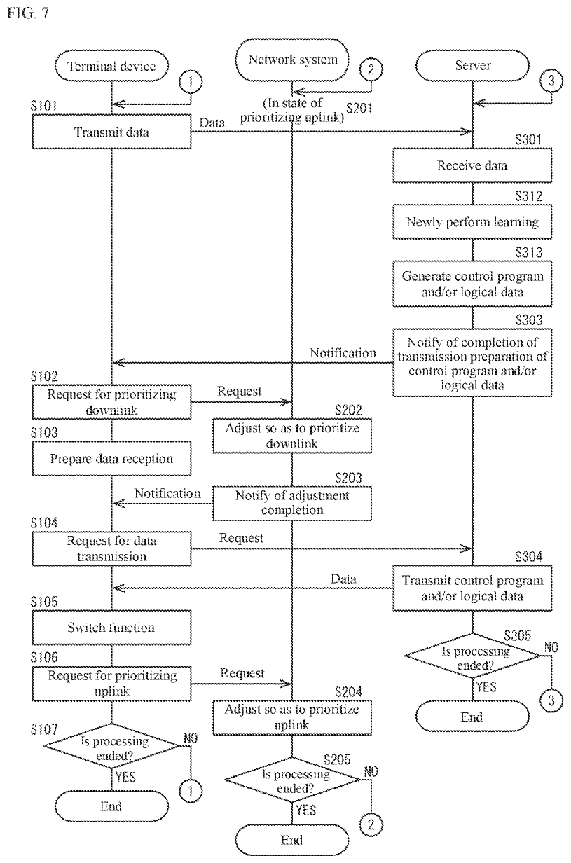

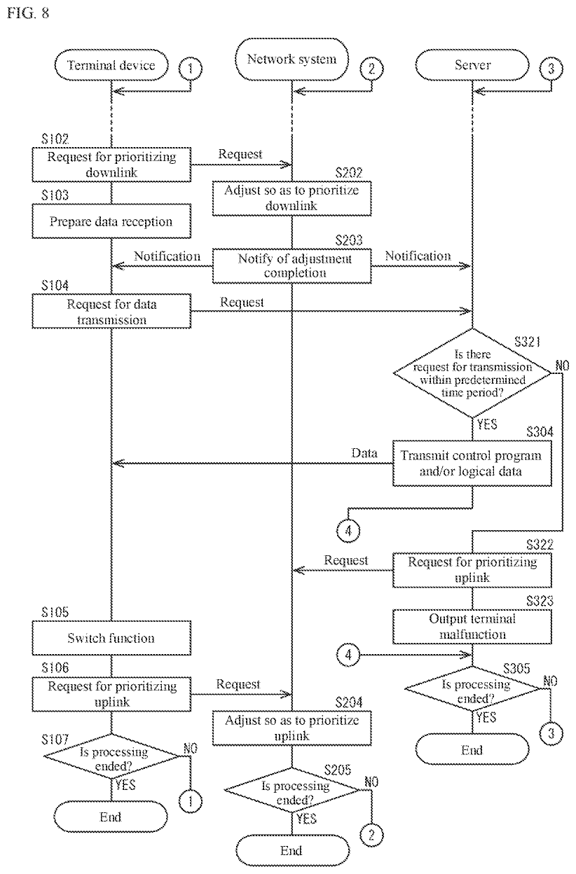

FIG. 7 is a flowchart illustrating processing procedure according to a second embodiment. Here, a processing procedure according to the second embodiment will be described based on the following assumptions. The terminal device 100 includes an image sensor. The terminal device 100 also performs predetermined machine learning on its own. The server 300 generates a control program and/or logical data for the function change of the terminal device 100. The server 300 changes the function of the terminal device 100 according to the learning result. In the drawings, the similar processing to that in the first embodiment is denoted by the same step number, and a description thereof will be omitted.

First, the terminal device 100 transmits, together with image data acquired by the image sensor, data on the analysis result of the image to the server 300 via the network system 200 (S101). At this time, the transport ratio in the network system 200 has already been adjusted so as to prioritize the uplink (S201). Then, the server 300 receives the date from the terminal device 100 (S301).

The analysis and/or learning in the terminal device 100 is, for example, machine learning using an image acquired by the image sensor as an input, that is, for example, inference by deep learning. At that time, as a result of analyzing the image acquired by the image sensor, a result with a low reliability score may appear in the terminal device 100. Such results are presented to the user to receive feedback of the correct answer. The terminal device 100 stores, in the storage 106, the image acquired by the image sensor together with the correct answer that is fed back as learning data. Specifically, for example, machine learning for identifying a person is performed. For example, in machine learning for identifying a person, persons wearing suits, persons wearing workwear, or the like have similar features, and thus misidentification is likely to occur. Thus, in the case of a score with low reliability, the terminal device 100 presents the result to the user and accepts the input of the correct answer according to the degree of the learning. This can improve the accuracy of learning data. Note that even when the score of the reliability is high, it is considered that the terminal device 100 may provide the user an incorrect result, so the terminal device 100 may receive input of learning data from the user.

The terminal device 100 transmits such machine learning results as learning data to the server 300. The timing to transmit the learning data may be, for example, a time when the stored amount of data of the image data detected by the sensor 109 has become not less than a threshold value. At this time, the terminal device 100 may transmit the image data together with the learning data.

Next, the server 300 that has received the learning data newly performs machine learning based on the received learning data (S312). Next, the server 300 generates a control program and/or logical data for the function change of the terminal 100 based on the new learning result (S313).

In the new machine learning by the server 300, the machine learning algorithm used in the machine learning performed by the terminal device 100 is confirmed. The confirmation of the machine learning algorithm is executed, for example, by storing, in the storage 340, the control program and/or the logical data that have been previously transmitted to the terminal device 100 and confirming it. Accordingly, the server 300 can identify the algorithm of machine learning that is the source of the received learning data. Based on such information, the server 300 determines an algorithm for new machine learning, for example, a deep learning network to be used for the new machine learning. The determined algorithm may be the same as or different from the algorithm used in the terminal device 100. Specifically, for example, in a case where the deep learning network used in the terminal device 100 is an old version, a deep learning network of a new version is determined from among deep learning networks of the same system/category. Subsequently, the server 300 uses the determined algorithm for machine learning to analyze and/or learn the image data from the terminal device 100.

When the learning is completed, the server 300 generates a control program and/or logical data based on the learning result. Specifically, for example, the server 300 generates a control program for controlling the used deep learning network. At that time, the program to be generated may be changed according to parameters such as an input resolution or an input channel. As the logical data, the circuit data of the FPGA is generated using the description file of the learned deep learning network and the model file of deep learning.

The subsequent processing procedure is the similar to that in the first embodiment, and the following processing is executed.
to notify of transmission of the control program and/or the logical data from the server 300 (S303)
to request for prioritizing the downlink (S102)
to prepare data reception (S103)
to adjust so as to prioritize the downlink (S202)
to notify of adjustment completion (S203)
to request for data transmission (S104)
to transmit a control program and/or logical data (S304)
to change function of the terminal device 100 (S105)
to request for prioritizing the uplink (S106)
to adjust so as to prioritize the uplink (S204), and the like.

The second embodiment described above has the following effects in addition to the effects of the first embodiment.

In the second embodiment, the server 300 performs learning using data of the terminal device 100, and generates a control program and/or logical data of the terminal device 100 based on a result of the learning performed by the server 300. Accordingly, in the second embodiment, artificial intelligence (AI) that becomes smarter by repeating more efficient data collection and positive feedback by machine learning using the collected data can be implemented. In particular, in the second embodiment, more advanced machine learning, machine learning with a large amount of data, or the like, which cannot be achieved only by the terminal device 100, can be executed by the server 300 having a higher function than the terminal device 100. Thus, in the second embodiment, while configuring the hardware resources of the terminal device 100 at a minimum, it is possible to execute a function change of the terminal device 100 based on more advanced learning while minimizing the hardware resources of the terminal device 100.

### Third Embodiment

A third embodiment is a control mode in a case where a malfunction occurs in the terminal device 100. Since the configuration of the communication system 1 of the third embodiment is the same as that of the first embodiment, the description thereof will be omitted.

A case according to the third embodiment is a case where no request for data transmission (S104) is output to the server 300 after the terminal device 100 receives a notification of adjustment completion for prioritizing the downlink (S203) from the network system.

FIG. 8 is a flowchart illustrating processing procedure according to a third embodiment. Here, a processing procedure when a malfunction occurs in the terminal device 100 will be described. Thus, the basic processing procedure is similar to that in the first or second embodiment, and a description thereof will be omitted. FIG. 8 illustrates a processing procedure after the step in the processing procedure of the first embodiment in which the request for prioritizing the downlink (S102) is transmitted from the terminal device 100.

According to the third embodiment, as a processing procedure of the network system 200, the completion of the adjustment of the transport ratio is also notified to the server 300. Then, the server 300 determines whether or not a request for data transmission has been received from the terminal device 100 within a predetermined time period following receipt of the notification (S321). For example, as a result of past records, the predetermined time period is preferably a time period that takes for a request to reach from the terminal device 100 to the server 300. Specifically, for example, it is about 0.1 to 30 seconds.

In the step of S321, when a request for data transmission is received from the terminal device 100 within the predetermined time period (S321: YES), the server 300 transmits the control program and/or the logical data (S304). Next, if there is no instruction to end the processing (S305: NO), the processing returns to S301 and the server 300 continues the processing. If there is an instruction to end the processing (S305: YES), the server 300 ends the processing.

On the other hand, on the step of S321, when no request for data transmission is received from the terminal device 100 within the predetermined time period (S321: NO), the server 300 requests the network system 200 to prioritize the uplink (S322).

Next, the network system 200 that has received the request for prioritizing the uplink adjusts the transport ratio to priority the uplink (S204). At this time, the network system 200 adjusts the transport ratio, for example, to a predetermined standard transport ratio in the case of prioritizing the uplink.

Next, the server 300 outputs to the terminal devices 100 (other than the terminal device in which a malfunction has occurred) out of the terminal devices used by the user or the like that the malfunction has occurred in the terminal device 100 (S323). Next, if there is no instruction to end the processing (S305: NO), the processing returns to S301 and the server 300 continues the processing. If there is an instruction to end the processing (S305: YES), the server 300 ends the processing.

Other processing procedure is similar to that in the first or second embodiment.

The third embodiment described above has the following effects in addition to the effects of the first and second embodiments.

The terminal device 100 normally requests the server 300 to perform data transmission (S104) after receiving the notification of the completion of prioritizing the downlink (S203) as described in the first or second embodiment above. Meanwhile, in a case where no request for data transmission (S104) is output to the server 300 from the terminal device 100, it is expected that a malfunction occurs in the terminal device 100.

In the third embodiment, a malfunction of the terminal device 100 is detected by determining whether or not the server 300 has received a request for data transmission within a predetermined time period. Then, in a case where the server 300 does not receive a request for data transmission from the terminal device 100 within the predetermined time period, the server 300 determines that a malfunction has occurred in the terminal device 100 and requests for prioritizing the uplink. Accordingly, in the third embodiment, for example, after recovering of the terminal device 100 from malfunctioning, it is possible to efficiently transmit data from the terminal device 100 to the server 300. In the third embodiment, the server 300 outputs that the malfunction has occurred in the terminal device 100 to the terminal devices 100 other than the malfunctioning terminal device 100. Thus, the user or the like of the terminal devices 100 and the server 300 can know the occurrence of the malfunction of the terminal device 100 via the terminal devices 100 other than the malfunctioning terminal device 100. The occurrence of the malfunction of the terminal device 100 may be displayed on the operation display 360 of the server 300.

Note that in the third embodiment, the server 300 determines the malfunction occurrence in the terminal device 100. However, the network system 200 (controller) may determine the malfunction occurrence in the terminal device 100. In this case, for example, the network system 200 monitors the presence or absence of data transmission to the terminal device 100 that has made a request for prioritizing the downlink. Then, when there is no data transmission from the server 300 to the terminal device 100 within a predetermined time period, the network system 200 makes an adjustment so as to return to the state of prioritizing the uplink.

### Forth Embodiment

A fourth embodiment is related to a control mode related to a timing of function change of the terminal device 100. Since the configuration of the communication system 1 of the fourth embodiment is the same as that of the first embodiment, the description thereof will be omitted.

The fourth embodiment is an example of function change of the terminal device 100 when there is no change in the content of data transmitted from the terminal device 100. For example, in this embodiment, the sensor 109 of the terminal device 100 is an image sensor such as a monitoring camera. In a case where image data having the same content that includes no moving person or object is continuously transmitted by the image sensor, the server 300 changes the function of the terminal device 100 to stop the data transmission until a person or an object is detected.

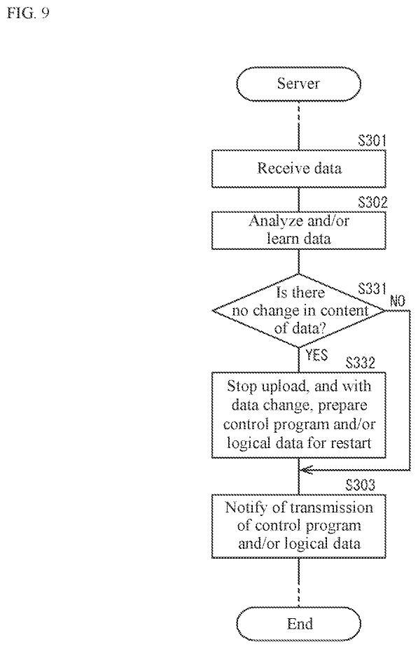

FIG. 9 is a flowchart illustrating processing procedure according to a fourth embodiment. In this embodiment, a processing procedure of the function change of the terminal device 100 by the server 300 will be described. This processing procedure is executed, for example, before the step of S303 in the first embodiment. Since other processing procedure is similar to that in the first embodiment, and a description thereof will be omitted.

After analyzing and/or learning of data (S302) in the first embodiment, the server 300 determines whether or not there is no change in the content of data received from the terminal device 100 (S331). For the determination of the content of the data, the result of the analysis and/or the learning (S302) is used. In the processing of the analysis and/or the learning of data (S302), analysis and/or learning of the data is performed in time series as already described. In a case of image data, when the server 300 determines that there is no change in the image during a predetermined time period (or there is no change that is beyond the predetermined range in pixel count). The predetermined time period for determining that there is no change is, for example, preferably set to be longer in a facility or in a time period with more people coming and going. This eliminates the need for frequent function change of the terminal device 100. Conversely, it is preferable to set the predetermined time period to be shorter in a facility or in a time period with less people coming and going. This can reduce unnecessary data transmission.

In a case where it is determined that there is no change in the step of S331 (S331: YES), the server 300 prepares the control program and/or logical data for function change of the terminal device 100 (S332). The control program and/or the logical data prepared here causes the terminal device 100 to determine whether or not there is a change in an image, stop data transmission (upload), and restart data transmission (upload) in an event of a change in the image. In addition, the control program and/or the logical data may cause the terminal device 100 to accumulate, in the storage 106, the data detected by the sensor 109 while the terminal device 100 stops data uploading.

In a case where there is a change in the step of S331 (S331: NO), similarly to the first embodiment, the processing proceeds to the step of S303 and the server 300 continues the subsequent processing.

Other processing procedure is similar to that in the first embodiment.

The fourth embodiment described above has the following effects in addition to the effects of the first to third embodiments.

In the fourth embodiment, the data transmission from the terminal device 100 is stopped when there is no change in the content of data, and the data transmission from the terminal device 100 is restarted in an event of a change in the image.

Thus, in the fourth embodiment, the amount of data transmitted to the communication channel can be reduced, so that the load on the communication channel can be reduced.

While the upload is stopped, a request for prioritizing the downlink may be transmitted from the terminal device 100 or the server 300, and during this period of time, a control program and/or logical data may be separately transmitted from the server 300 to the terminal device 100, for example. Accordingly, it is possible to effectively use the period of time during which the upload is stopped.

In addition, by recording a period of time during which the upload is stopped, the terminal device 100 or the server 300 can utilize the records as past records. By utilizing the past records, for example, it is possible to confirm that in a residential facility, there is a time period, such as a meal time or a bathing time, during which the image remains unchanged.

Note that although the server 300 determines to stop the upload and changes the function of the terminal device 100 in the fourth embodiment, the present invention is no limited thereto. For example, by storing in advance, in the terminal device 100, a control program and/or logical data for determining an image change, the terminal device 100 itself may determine the presence or absence of an image change to stop and resume the upload.

In addition, the stop of the upload may be performed periodically based on the past records or other data. For example, as described above, the upload may be stopped in a time period in which it is determined, from the past records, that there is no person, and the upload may be restarted when a person is detected. The stop of the upload may be executed by utilizing other data. As the other data, for example, in stations or the like, information of departures and arrivals timetable of public transportation is used. In this case, the upload may be stopped in a time period during which people are gone from the station premises, and the upload may be restarted when a person is detected.

Although the embodiments of the present invention have been described above, the present invention is not limited to the embodiments. The conditions, numerical values, and the like used in the description of the embodiments are merely for explanation, and the present invention is not limited to these conditions and numerical values.

The communication control program according to the present invention can also be implemented by a dedicated hardware circuit. In addition, the communication control program may be provided by a computer-readable recording medium such as a universal serial bus (USB) memory, a digital versatile disc (DVD)-read only memory (ROM), or the like. The communication control program may be provided online via a network such as the Internet, or the like without using the recording medium. In a case where a communication control program is provided online, the communication control program is recorded on a recording medium (storage) such as a magnetic disk, or the like in a computer connected to a network.

In addition, the present invention can be modified in various manners based on the configurations described in the claims, and those modifications are also within the scope of the present invention.

This application is based on Japanese Patent Application No. 2021-9446 filed on Jan. 25, 2021, the disclosure of which is incorporated herein by reference in its entirety.

### REFERENCE SIGNS LIST

1 communication system
100 terminal device
100a portable terminal device
100c monitoring camera device
101 wireless communicator
102 channel transport ratio change request unit
103 data reception processing unit
104 analysis learning internal setting change unit
105 control program/logical data unit
106 storage
109 sensor
110 SoCFPGA
150 5G communication interface
160 operation display
200 network system
201 wireless communication controller
202 channel transport ratio controller (controller)
203 processing relay determination unit
300 server
301 wireless communicator
302 terminal data analysis learning unit
303 control program/logical data generator
304 generation completion notification unit

1. A communication system comprising:
a terminal device including a sensing device;
a network system at least a part of which includes wireless communication; and
a server that performs data transport with the terminal device through the network system via wireless communication, wherein
the communication system includes a hardware processor that dynamically controls a transport ratio of an uplink channel to a downlink channel, considering a direction from the terminal device to the server is an uplink channel and a direction from the server to the terminal device is a downlink channel, and
the hardware processor adjusts the transport ratio according to a condition of data transport or a type of data transport.

2. The communication system according to claim 1, wherein
the hardware processor adjusts the transport ratio to make a transport amount of the uplink channel larger when an amount of data from the terminal device to the server is larger than an amount of data from the server to the terminal device.

3. The communication system according to claim 1, wherein
the hardware processor adjusts the transport ratio to make a transport amount of the downlink channel larger when an amount of data from the server to the terminal device is larger than an amount of data from the terminal device to the server.

4. The communication system according to claim 1, wherein
the hardware processor adjusts the transport ratio in response to a request from the terminal device.

5. The communication system according to claim 4, wherein
the terminal device requests the hardware processor to make a transport amount of the downlink channel larger on reception of a notification of completion of data transmission preparation from the server.

6. The communication system according to claim 5, wherein
the server notifies the terminal device of data size of data to be transmitted to the terminal device.

7. The communication system according to claim 6, wherein
the terminal device requests to adjust the transport ratio according to the data size.

8. The communication system according to claim 5, wherein
the server notifies the terminal device of viability of suspension of data transmission,
the terminal device includes a storage that stores data, and
the terminal device stores data from the sensing device in the storage in a case where data transmission cannot be suspended.

9. The communication system according to claim 1, wherein
the terminal device requests the hardware processor to make a transport amount of the uplink channel larger after completion of reception of data transmitted from the server.

10. The communication system according to claim 9, wherein,
the hardware processor adjusts the transport ratio to make a transport amount of the uplink channel larger when there is no request for transport ratio change from the terminal device within a predetermined time period after adjustment for making a transport amount of the downlink channel larger.

11. The communication system according to claim 9, wherein
the server requests the hardware processor to make a transport amount of the uplink channel larger when there is no request for data transmission from the terminal device within a predetermined time period after the transport ratio is adjusted to make a transport amount of the downlink channel larger by the hardware processor.

12. The communication system according to claim 1, wherein
the server generates a control program and/or logical data for operating the terminal device and transmits the control program and/or the logical data to the terminal device.

13. The communication system according to claim 12, wherein
the hardware processor adjusts the transport ratio to make a transport amount of the downlink channel larger during transmission of the control program and/or the logical data.

14. The communication system according to claim 13, wherein
the control program and/or the logical data includes a machine learning algorithm used in the terminal device.

15. The communication system according to claim 12, wherein
the server notifies the terminal device that transmission preparation of the control program and/or the logical data is completed.

16. The communication system according to claim 1, wherein
the terminal device and/or the server learns using data obtained by the sensing device and changes a function of the terminal device.

17. The communication system according to claim 1, wherein
the terminal device includes a plurality of the sensing devices.

18. A non-transitory recording medium storing a computer readable communication control program for controlling a communication system comprising: a terminal device including a sensing device; a network system at least a part of which includes wireless communication; a server that performs data transport with the terminal device through the network system via wireless communication; and a computer that dynamically controls a transport ratio of an uplink channel to a downlink channel, considering a direction from the terminal device to the server is an uplink channel and a direction from the server to the terminal device is a downlink channel,
the computer readable communication control program causing the computer to execute:
a step (a) of adjusting the transport ratio according to a condition of data transport or a type of data transport.

19. The non-transitory recording medium according to claim 18, wherein
the step (a) includes adjusting the transport ratio to make a transport amount of the uplink channel larger when an amount of data from the terminal device to the server is larger than an amount of data from the server to the terminal device.

20. The non-transitory recording medium according to claim 18, wherein,
the step (a) includes adjusting the transport ratio to make a transport amount of the downlink channel larger when an amount of data from the server to the terminal device is larger than an amount of data from the terminal device to the server.

21. The non-transitory recording medium according to claim 18, wherein
the step (a) includes adjusting the transport ratio in response to a request from the terminal device.

22. The non-transitory recording medium according to claim 21, wherein the computer readable communication control program further causes the computer to execute:
a step (b) of adjusting the transport ratio to make a transport amount of the uplink channel larger when there is no request for transport ratio change from the terminal device within a predetermined time period after adjustment for making a transport amount of the downlink channel larger in the step (a).

23. A communication control method for controlling a communication system comprising a terminal device including a sensing device, a network system at least a part of which includes wireless communication, and a server that performs data transport with the terminal device through the network system via wireless communication, the communication control method comprising:
dynamically controlling a transport ratio of an uplink channel to a downlink channel according to a condition of data transport or a type of data transport, considering a direction from the terminal device to the server is an uplink channel and a direction from the server to the terminal device is a downlink channel.
